(19) United States
(12) Patent Application Publication
(10) Pub. No.: US 2007/0086662 A1
(43) Pub. Date: Apr. 19, 2007

(54) Apparatus and method for processing image data using error diffusion

(75) Inventors: Jeong-Hwan Cho, Suwon-si (KR); Eul-Hwan Lee, Seongnam-si (KR); Won-Kyoung Cho, Jeonju-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/522,980

(22) Filed: Sep. 19, 2006

(30) Foreign Application Priority Data
Oct. 17, 2005 (KR) 2005-97577

(51) Int. Cl. G06K 9/36; G06K 9/40

(52) U.S. Cl. 382/233; 382/254

(57) ABSTRACT

An apparatus and method are provided for processing image data using error diffusion. The apparatus and method decode image data compressed in a joint photographic experts group (JPEG) format, convert the image data into color coordinates without storing the image data in a memory, and perform a binarization by calculating error values in accordance with the image data in the unit of block to generate a final output data which is 1 bit long. Since the apparatus and method for processing image data using error diffusion do not require an operation of transmitting and storing the image data to a system memory through a DMA controller, the performance of a system is improved. Also, since the memory does not require a large storage space to store the decoded image data, its utility is improved.

### CROSS-REFERENCE TO RELATED APPLICATION

This application claims the benefit under 35 U.S.C. §119(a) of Korean Patent Application No. 2005-97577, filed in the Korean Intellectual Property Office on Oct. 17, 2005, the entire disclosure of which is hereby incorporated by reference.

### BACKGROUND OF THE INVENTION

1. Field of the Invention

The present invention relates to an apparatus and method for processing image data using error diffusion. More particularly, the present invention relates to an apparatus and method for processing image data using error diffusion, which decodes image data compressed in a joint photographic experts group (JPEG) format, converts the image data into color coordinates without storing the image data in a memory, and performs a binarization by calculating error values in accordance with the image data in the unit of block to generate a final output data which is 1 bit long.

2. Description of the Related Art

Typically, an image processing apparatus compresses image data corresponding to an image input from an external device in a joint photographic experts group (JPEG) format. The image processing apparatus stores the compressed image data to a memory by performing a direct memory access (DMA) operation. Also, the image processing apparatus reads out the image data from the memory by performing the DMA operation at the external device's request. The DMA operation is controlled by a DMA processor, not by a central processing unit (CPU), and directly transmits data from the memory connected to a bus which is connected to a channel or vice versa.

FIG. 1A is a block diagram illustrating a conventional image processing apparatus capable of decoding image data.

The conventional image processing apparatus 100 comprises an image data pre-processor 110, a memory 120, a DMA controller 130, an image compressor 140, and an image data decoder 150.

The image data pre-processor 110 outputs a luminance component Y and chrominance components Cb and Cr of image data at any one of the following sampling ratios: Y:Cb:Cr=4:4:4; Y:Cb:Cr=4:2:2; or Y:Cb:Cr=4:1:1. The image data pre-processor 100 outputs the image data in the order of Y, Cb, Cr in the form of a raster image which is represented in the unit of line.

The DMA controller 130 stores the image data output in the unit of line to each area of the memory 120 according to the components of the image data. The DMA controller 130 reads out the image data components Y, Cb, Cr from the memory 120 at any one of the following sampling ratios: Y:Cb:Cr=4:4:4; Y:Cb:Cr=4:2:2; or Y:Cb:Cr=4:1:1 in the unit of block consisting of 8×8 pixels, and transmits the image data components Y, Cb, Cr to the image compressor 140.

The image compressor 140 encodes and compresses the transmitted image data components into binary data using a discrete cosine transform (DCT), a quantization, and Huffman code, sequentially. The compressed image data is stored in the memory 120.

The image data decoder 150 performs the reverse operation of that of the image compressor 140, thereby decoding the image data into any one of the following formats: Y:Cb:Cr=4:4:4; Y:Cb:Cr=4:2:2; or Y:Cb:Cr=4:1:1. Also, the DMA controller 130 stores the respective image data components in the memory 120. The respective image data components are decoded into any one of the following formats: Y:Cb:Cr=4:4:4; Y:Cb:Cr=4:2:2; or Y:Cb:Cr=4:1:1, to the memory 120. Next, the DMA processor 130 converts the image data into CMYK color coordinates that are compatible with a printer when the decoding of a certain amount of image data is completed. The DMA processor 130 then binarizes the image data into a final image data of 1 bit that is compatible with the printer.

An error diffusion method is frequently used to binarize image data. As shown in FIG. 1B, a conventional error diffusion binarization method performs a calculation according to image data consisting of 8×8 pixels in the unit of line. More specifically, a calculation in accordance with a first row of image data consisting of pixels a₀₀, a₁₀, a₂₀, a₃₀, a₄₀, a₅₀, a₆₀, a₇₀ is performed and stored in the memory 120. Next, a calculation with respect to a second row of image data consisting of pixels a₀₁, a₁₁, a₂₁, a₃₁, a₄₁, a₅₁, a₆₁, a₇₁ is performed and stored in the memory 120. Next, calculations are performed in the order of third, fourth, fifth, sixth, and seventh rows. A final calculation is calculated and stored in the memory 120 with respect to a final row of image data consisting of pixels a₀ₙ, a₁ₙ, a₂ₙ, . . . , a₍ₘ₋₁₎ₙ, aₘₙ.

According to the error diffusion binarization performed in the unit of line as described above, the first row of image data may have a correlation with the second row of image data as shown in FIG. 1, although the image data consisting of 8×8 pixels is converted into the CMYK color coordinates. Therefore, if the calculations for the error diffusion binarization are stopped, an error occurs in the unit of row and a final printed image data is difficult to perceive.

Accordingly, there is a need for an improved system and method for processing image data using error diffusion.

### SUMMARY OF THE INVENTION

An aspect of exemplary embodiments of the present invention is to address at least the above problems and/or disadvantages and to provide at least the advantages described below. According to an aspect of exemplary embodiments of the present invention, an apparatus and method for processing image data using error diffusion is provided. Image data compressed in a JPEG format is decoded and converted to color coordinates without storing the image data in a memory. A binarization is performed by calculating error values with respect to the image data in the unit of block in a diagonal direction to generate a final output data which is 1 bit long.

The above aspect of the exemplary embodiments of the present invention is achieved by providing an image data processing apparatus. The image data processing apparatus includes an image decoder that decodes image data compressed in a joint photographic experts group (JPEG) format into a predetermined block form according to a sampling ratio. A color coordinates converter and an error diffusion binarization unit are also included. The color coordinates converter converts the decoded image data into color coordinates and the error diffusion binarization unit performs a binarization by calculating error values in a diagonal direction with respect to the image data which is converted into the color coordinates.

The above aspect is also achieved by providing a method for processing image data using error diffusion. Image data compressed in a JPEG format is decoded into a predetermined block form according to a sampling ratio. The decoded image data is converted into color coordinates and an error diffusion binarization is performed by calculating error values in a diagonal direction with respect to the image data which is converted into the color coordinates.

Preferably, the predetermined block form consists of 8×8 pixels, and the color coordinates are CMYK color coordinates including cyan, magenta, and yellow. Preferably, the sampling ratio is one of the following: Y:Cb:Cr=4:4:4; Y:Cb:Cr=4:2:2; or Y:Cb:Cr=4:1:1. With reference to the sampling ration, Y denotes a luminance component and Cb and Cr denote a chrominance component.

The error diffusion binarization unit performs a binarization by calculating a first error value using a pixel lying in a first row and a first column and a pixel lying in the first row and a second column. A second error value is calculated using the pixel lying in the first row and the second column and a pixel lying in a second row and the first column. A third error value is calculated using a pixel lying in the first row and a third column, a pixel lying in the second row and the second column, and a pixel lying in a third row and the first column. The subsequent error values are calculated using the same pattern as described above.

Preferably, but not necessarily, the error diffusion binarization unit performs a binarization by calculating row-directional error values using pixels lying in each row, wherein a last pixel used to calculate a certain row-directional error value is diagonally ahead of one used to calculate a previous row-directional error value of the certain row-directional error value.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features and advantages of certain exemplary embodiments of the present invention will become apparent and more readily appreciated from the following description of the embodiment, taken in conjunction with the accompanying drawings of which:

FIG. 1A is a block diagram illustrating a conventional image processing apparatus having the capability of decoding image data;

FIG. 1B is a view explaining a conventional error diffusion binarization method to perform a calculation in the unit of line;

FIG. 2 is a block diagram schematically illustrating an image data processing apparatus according to an exemplary embodiment of the present invention;

FIG. 3 is a view illustrating an error diffusion binarization method according to a first exemplary embodiment of the present invention; and

FIG. 4 is a view illustrating an error diffusion binarization method according to a second exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

A general error diffusion method will be described for the sake of understanding the exemplary embodiments of the present invention.

An image displayer displays a grayscale image on a display panel according to a sequence of incoming image data. A quantization process is required to represent an original image having grayscale values by color on the image displayer which may have low grayscale values. This is due to the fact that the grayscale values reproducible on the image displayer are limited. Therefore, a difference occurs between the grayscale value of the original image and the grayscale value output to the display panel.

One approach to reducing the difference occurring between the grayscale value output to the display panel and the grayscale value of the original is error diffusion. Error diffusion refers to the process of diffusing an error occurring in a certain pixel during the quantization to neighboring pixels and thereby generating support for grayscales with respect to the neighboring pixels within a predetermined area. Error diffusion greatly improves a driving performance of the image displayer at a low cost and also easily obtains a sufficient image grayscale.

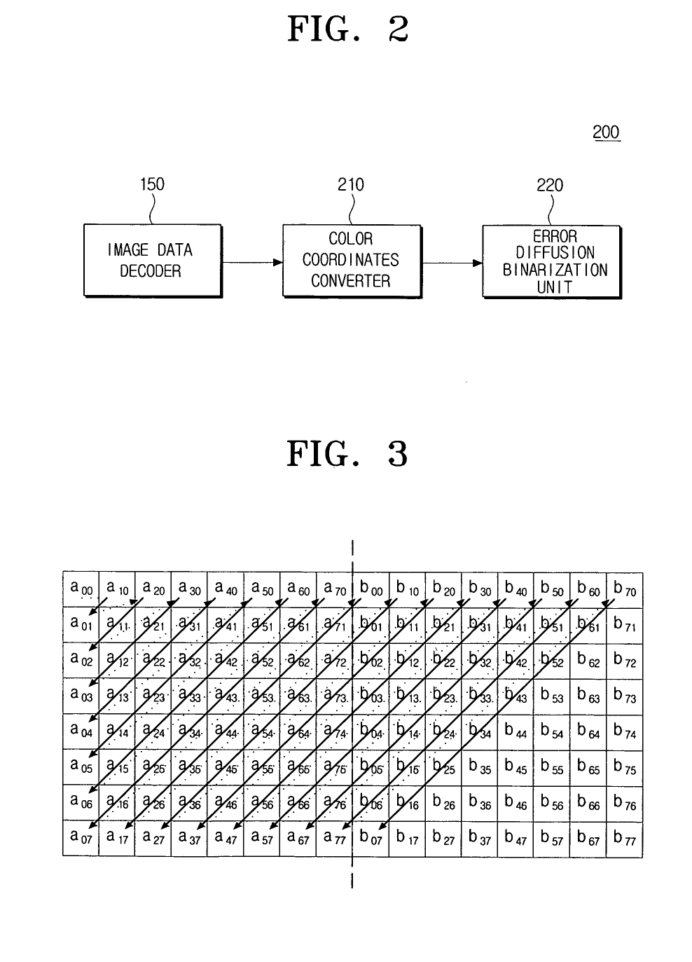

FIG. 2 is a block diagram illustrating an image data processing apparatus 200 according to an exemplary embodiment of the present invention.

As shown in FIG. 2, the image data processing apparatus 200, according to an exemplary embodiment of the present invention, comprises an image data decoder 150, a color coordinates converter 210, and an error diffusion binarization unit 220.

The image data processing apparatus 200, according to an exemplary embodiment of the present invention, does not have a DMA controller 130. Alternatively, the conventional image processing apparatus 100 may have a DMA controller 130. Accordingly, the image data processing apparatus 200 does not require an operation of storing decoded image data in the memory 120 through the DMA controller 130.

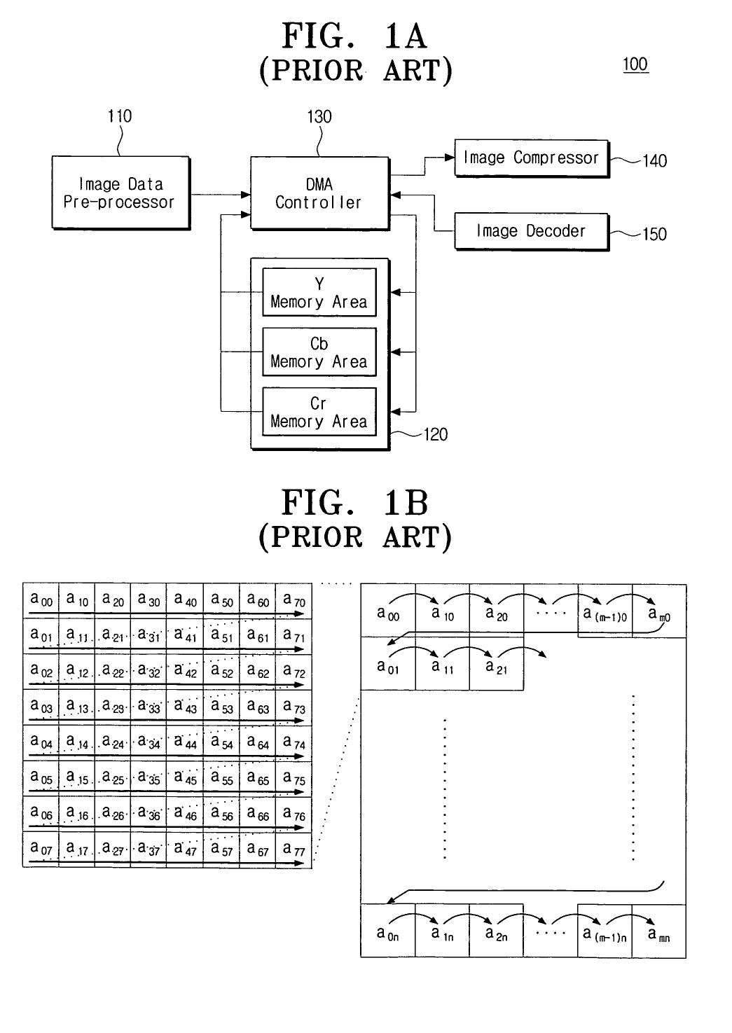

Since the image data pre-processor 110 and the memory 120 were described with reference to FIG. 1A, they are omitted from FIG. 2 for clarity and conciseness.

The image data decoder 150 decodes compressed image data into specific formats according to a sampling ratio. For example, the image data decoder 150 decodes compressed image data into any one of the following formats: Y:Cb:Cr=4:4:4; Y:Cb:Cr=4:2:2; or Y:Cb:Cr=4:1:1 according to a sampling ratio. The decoded image data is in the unit of block consisting of 8×8 pixels.

The color coordinates converter 210 converts the image data which is decoded by the image data decoder 150 into CMYK color coordinates which are compatible with a printer.

A color printer mixes three ink colors of cyan, magenta, yellow based on the CMYK color coordinates and thereby prints a color image. There are 7 combinations of colors available for one pixel, such as cyan (C), magenta (M), yellow (Y), blue (B=cyan+magenta; C+M), red (R=magenta+yellow; M+Y), green (G=yellow+cyan; Y+C), and black (B=cyan+magenta+yellow; C+M+Y). If white is added in the combinations, it is possible to print 8 colors of image. To perform a color error diffusion binarization, a target pixel is designated in the raster scanning order, and color components of the target pixel are divided and converted into C, M, and Y.

The error diffusion binarization unit 220 performs a binarization by calculating error values with respect to image data consisting of blocks. Each block consists of 8×8 pixels in a diagonal direction as shown in FIG. 3.

Also, the error diffusion binarization unit 220 performs a binarization by calculating error values in a row direction. Herein, a last pixel used to calculate a certain error value is diagonally ahead of one used to calculate the previous error value of the certain error value.

FIG. 3 is a view illustrating an error diffusion binarization method according to a first exemplary embodiment of the present invention.

There are well-known error diffusion methods such as Floyd-Steinberg and Stucki. The Floyd-Steinberg error diffusion method is commonly used to convert grayscale or continuous-tone color images into something with a small number of bits per pixel. The exemplary embodiments of the present invention employ the Floyd-Steinberg error diffusion method.

As shown in FIG. 3, the error diffusion binarization method according to the first exemplary embodiment of the present invention calculates a first error value e₀₀ using a pixel a₀₀ lying in the first row and the first column and a pixel a₁₀ lying in the first row and the second column. The error diffusion binarization method calculates a second error value e₁₀ using a pixel a₁₀ lying in the first row and the second column and a pixel a₀₁ lying in a diagonal direction to the pixel a₁₀, that is lying in the second row and the first column.

A third error value e₂₀ is calculated using a pixel a₂₀ lying in the first row and the third column, a pixel a₁₁ lying in a diagonal direction to the pixel a₂₀, that is lying in the second row and the second column, and a pixel a₀₂ lying in a diagonal direction to the pixel a₁₁, that is lying in the third row and the first column.

A fourth error value e₃₀ is calculated using a pixel a₃₀ lying in the first row and the fourth column, a pixel a₂₁ lying in the second row and the third column, a pixel a₁₂ lying in the third row and the second column, and a pixel a₀₃ lying in the fourth row and the first column. A fifth error value e₄₀ is calculated using a pixel a₄₀ lying in the first row and the fifth column, a pixel a₃₁ lying in the second row and the fourth column, a pixel a₂₂ lying in the third row and the third column, a pixel a₁₃ lying in the fourth row and the second column, and a pixel a₀₄ lying in the fifth row and the first column.

A sixth error value e₅₀ is calculated using a pixel a₅₀ lying in the first row and the sixth column, a pixel a₄₁ lying in the second row and the fifth column, a pixel a₃₂ lying in the third row and the fourth column, a pixel a₂₃ lying in the fourth row and the third column, a pixel a₁₄ lying in the fifth row and the second column, and a pixel a₀₅ lying in the sixth row and the first column. A seventh error value e₆₀ is calculated using a pixel a₆₀ lying in the first row and the seventh column, a pixel a₅₁ lying in the second row and the sixth column, a pixel a₄₂ lying in the third row and the fifth column, a pixel a₃₃ lying in the fourth row and the fourth column, a pixel a₂₄ lying in the fifth row and the third column, a pixel a₁₅ lying in the sixth row and the second column, and a pixel a₀₆ lying in the seventh row and the first column.

An eighth error value e₇₀ is calculated using a pixel a₇₀ lying in the first row and the eighth column, a pixel a₆₁ lying in the second row and the seventh column, a pixel a₅₂ lying in the third row and the sixth column, a pixel a₄₃ lying in the fourth row and the fifth column, a pixel a₃₄ lying in the fifth row and the fourth column, a pixel a₂₅ lying in the sixth row and the third column, a pixel a₁₆ lying in the seventh row and the second column, and a pixel a₀₇ lying in the eighth row and the first column. Briefly, the binarization is performed by calculating error values in the diagonal direction.

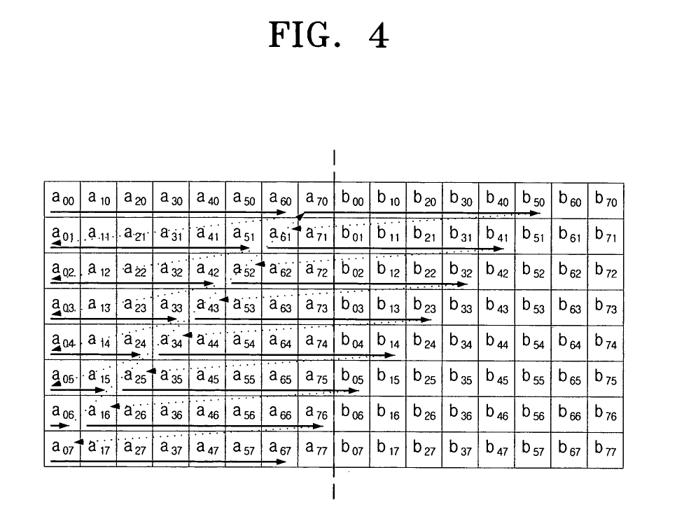

FIG. 4 is a view illustrating an error diffusion binarization method according to a second exemplary embodiment of the present invention.

The error diffusion binarization method according to the second exemplary embodiment of the present invention performs a binarization by calculating error values with respect to image data in the unit of block in a horizontal direction, such as, calculating row-directional error values using pixels in each row. At this time, the last pixel used to calculate a certain error value is diagonally ahead of one used to calculate the previous error value of the certain error value.

More specifically, as shown in FIG. 4, a first row error value is calculated using pixels a₀₀, a₁₀, a₂₀, a₃₀, a₄₀, a₅₀, and a₆₀ lying in the first to the seventh columns of the first row, respectively. A second row error value is calculated using pixels a₀₁, a₁₁, a₂₁, a₃₁, a₄₁, and a₅₁, lying in the first to the sixth columns of the second row, respectively.

A third row error value is calculated using pixels a₀₂, a₁₂, a₂₂, a₃₂, and a₄₂ lying in the first to the fifth column of the third row which is diagonally ahead of the last pixel a₅₁(sixth column) used to calculate the second row error value. A fourth row error value is calculated using pixels a₀₃, a₁₃, a₂₃, and a₃₃ lying in the first column to the fourth column of the fourth row which is diagonally ahead of the last pixel a₄₂ used to calculate the third row error value. The fifth, the sixth and the seventh error values are calculated using the same pattern. Preferably, the seventh error value is calculated using only the first column pixel a₀₆ of the seventh row so that the calculation of error values for the first block ‘a’ is completed.

The calculation of a first row error value for the second block ‘b’ begins with seven pixels a₇₀ to b₅₀ lying in the eighth column of the first row to the sixth column of the second block ‘b’. That is, one row consisting of seven pixels is used to calculate each error value.

A second row error value is calculated using seven pixel a₆₁ to b₄₁ lying in the seventh column of the second row of the first block ‘a’ to the fifth column of the second row of the second bock ‘b’ which is diagonally ahead of the last pixel b₅₀ used to calculate the first row error value.

A third row error value is calculated using seven pixel values a₅₂ to b₃₂ lying in the sixth column of the third row of the first block ‘a’ to the fourth column of the third row of the second block ‘b’ which is diagonally ahead of the last pixel b₄₁ used to calculated the second row error value.

The fourth row error value is calculated using pixels a₄₃ to b₂₃ which is diagonally ahead of the last pixel b₃₂ used to calculate the third row error value. The fifth row error value is calculated using pixels a₃₄ to b₁₄, and the sixth row error value is calculated using pixels a₂₅ to b₀₅.

Next, the error diffusion binarization unit 220 calculates a seventh row error value using pixel a₁₆ to a₇₆, and calculates an eighth row error value using pixels a₀₇ to a₆₇.

Briefly, the error diffusion binarization unit 220 performs a binarization by calculating error values with respect to the image data in the unit of block in the horizontal direction using the pixels in each row, wherein the last pixel used to calculate a certain error value is diagonally ahead of one used to calculate the previous error value of the certain error.

According to exemplary embodiments of the present invention as described above, the performance of the system can be improved since the apparatus and method for processing image data using error diffusion does not require an operation of transmitting and storing the image data in a system memory through a DMA controller. Also, since the memory does not require a large storage space to store the decoded image data, utility can be improved.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An image data processing apparatus comprising:
an image decoder for decoding image data compressed in a joint photographic experts group (JPEG) format into a block form according to a sampling ratio;
a color coordinates converter for converting the decoded image data into color coordinates; and
an error diffusion binarization unit for performing a binarization by calculating error values in a diagonal direction in accordance with the image data which is converted into the color coordinates.

2. The image data processing apparatus as claimed in claim 1, wherein the block form consists of 8×8 pixels.

3. The image data processing apparatus as claimed in claim 1, wherein the color coordinates comprises CMYK color coordinates further comprising cyan, magenta, and yellow.

4. The image data processing apparatus as claimed in claim 1, wherein the error diffusion binarization unit performs a binarization by calculating a plurality of error values based on a plurality of diagonally related pixels.

5. The image data processing apparatus as claimed in claim 1, wherein the sampling ratio comprises at least one of Y:Cb:Cr=4:4:4, Y:Cb:Cr=4:2:2, and Y:Cb:Cr=4:1:1, wherein Y denotes a luminance component and Cb and Cr denote a chrominance component.

6. The image data processing apparatus as claimed in claim 1, wherein the error diffusion binarization unit performs a binarization by calculating row-directional error values using pixels lying in each row, wherein a last pixel used to calculate a certain row-directional error value is diagonally ahead of one used to calculate a previous row-directional error value of the certain row-directional error value.

7. A method for processing image data using error diffusion, comprising:
decoding image data compressed in a JPEG format into a block form according to a sampling ratio;
converting the decoded image data into color coordinates; and
performing an error diffusion binarization by calculating error values in a diagonal direction in accordance with the image data which is converted into the color coordinates.

8. The method as claimed in claim 7, wherein the sampling ratio of the image decoding operation comprises at least one of Y:Cb:Cr=4:4:4, Y:Cb:Cr=4:2:2, and Y:Cb:Cr=4:1:1, wherein Y denotes a luminance component and Cb and Cr denote a chrominance component.

9. The method as claimed in claim 7, wherein the color coordinates comprises CMYK color coordinates comprising cyan, magenta, and yellow.

10. The method as claimed in claim 7, wherein in accordance with the image data in the unit of block, the error diffusion binarization operation performs a binarization by calculating a plurality of error values based on a plurality of horizontally related pixels.

11. The method as claimed in claim 7, wherein in accordance with the image data in the unit of block, the error diffusion binarization operations performs a binarization by calculating row-directional error values using pixels lying in each row, wherein a last pixel used to calculate a certain row-directional error value is diagonally ahead of one used to calculate a previous row-directional error value of the certain row-directional error value.

12. The image data processing apparatus as claimed in claim 4, wherein the error diffusion binarization unit performs a binarization by calculating a first error value using a pixel lying in a first row and a first column and a pixel lying in the first row and a second column.

13. The image data processing apparatus as claimed in claim 4, wherein the error diffusion binarization unit performs a binarization by calculating a second error value using the pixel lying in a first row and a second column and a pixel lying in a second row and a first column.

14. The image data processing apparatus as claimed in claim 4, wherein the error diffusion binarization unit performs a binarization by calculating a third error value using a pixel lying in a first row and a third column, a pixel lying in a second row and a second column, and a pixel lying in a third row and a first column.

15. The image data processing apparatus as claimed in claim 4, wherein the error diffusion binarization unit performs binarization by calculating a fourth error value using a pixel lying in a first row and a fourth column, a pixel lying in a second row and a third column, a pixel lying in a third row and a second column, and a pixel lying in a fourth row and a first column.

16. The method as claimed in claim 10, wherein the error diffusion binarization operation performs a binarization, in accordance with the image data in the unit block, by calculating a first error value using a pixel lying in a first row and a first column and a pixel lying in the first row and a second column.

17. The method as claimed in claim 10, wherein the error diffusion binarization operation performs a binarization, in accordance with the image data in the unit block, by calculating a second error value using the pixel lying in the first row and the second column and a pixel lying in a second row and the first column.

18. The method as claimed in claim 10, wherein the error diffusion binarization operation performs a binarization, in accordance with the image data in the unit block, by calculating a third error value using a pixel lying in the first row and a third column, a pixel lying in the second row and the second column, and a pixel lying in a third row and the first column.
